(19) United States
(12) Patent Application Publication
(10) Pub. No.: US 2026/0327776 A1
(43) Pub. Date: Oct. 22, 2026

(54) DEVICE AND METHOD FOR THE PLASMA TREATMENT OF METAL SURFACES

(71) Applicant: Oerlikon Surface Solutions AG, Pfäffikon, Pfäffikon (CH)

(72) Inventors: Michael ZUMKELLER-NEIDLINGER, Lörrach (DE); Uwe HORSCHIG, Schopfheim (DE)

(73) Assignee: Oerlikon Surface Solutions AG, Pfäffikon, Pfäffikon (CH)

(21) Appl. No.: 19/112,305

(22) PCT Filed: Sep. 18, 2023
(86) PCT No.: PCT/EP2023/075607

§ 371 Date: Mar. 17, 2025

(30) Foreign Application Priority Data
Sep. 16, 2022 (DE) 10 2022 123 825.3

(51) Int. Cl. C23C 8/38; C21D 1/09; C23C 8/02

(52) U.S. Cl. CPC C23C 8/38; C21D 1/09; C23C 8/02

(57) ABSTRACT

Device and method for stable plasma treatment of components, in particular of large components with individual weights of between 500 kg and 40 tons, the device comprising a treatment chamber in the form of a horizontal cylinder with at least one lateral cylinder cover, and a special sealing system, the device and the methods enabling stable plasma treatment of such components, in particular of large tools such as, for example, large forming tools.

The present invention relates to the plasma treatment of metal surfaces, in particular metal surfaces of large components, to produce large components with modified metal surfaces.

Components in the context of the present invention are generally understood to be any parts or substrates with metal surfaces, with large components being defined in particular as those having weights in the range from 500 kg to 40 tons (between five hundred kilograms and forty tons).

Accordingly, the term components is used in the context of the present description in particular for tools and tool parts as well as for workpieces.

The plasma treatment according to the present invention can be used in particular for the modification of metal surfaces of tools which are used in manufacturing methods, such as forming and plastics processing, such as injection molding (called “Kunststoffverarbeitung” or “Spritzgiessen” in German) and extrusion methods (in the extrusion method, in particular long-fiber-reinforced thermoset semi-finished products with modified metal surfaces can be used, which are also simply referred to as SCM in German-speaking countries due to their designation in English as “Sheet Molding Compound”).

A large area of application for such components with modified metal surfaces is in forming technology, particularly in the processing of products for the automotive industry. Well-known products processed in this way are, for example, outer skin and structural parts for the automotive industry (e.g. doors, flaps, side wall, hoods). Such forming tools (hereinafter also referred to as tool parts) can, for example, have individual tool part weights of 500 kg to 40 tons. Accordingly, such forming tools are also referred to as large components in the present description.

Components or large components with modified metal surfaces are also molds that are treated for use in the plastics industry, for example for processing bumpers, car headlights, plastic parts in the interior and exterior of the automobile and household appliances.

Within the scope of the present description, for example, large components such as gear wheels, rollers and disks can also be treated to produce modified metal surfaces.

However, the above-mentioned components or large components with modified metal surfaces are to be understood merely as examples of large components within the scope of the present invention, and should therefore not be considered as limiting the use of the inventive device or method for plasma treatment of metal surfaces.

Different requirements are placed on the surfaces of components depending on the application.

For example, in the case of forming tools for metal forming, the requirements are considerable, so that at least the following requirements should be met:
High hardness,
High corrosion and wear resistance,
Low coefficient of friction,
Fatigue resistance,
Polishing capability
Repairability (overhaul).

The general trend in the car body construction industry is towards a reduction in lubricants (particularly with regard to the use of lubricants in the forming process) and vehicle weight. The resulting limited use of lubricants in conjunction with the introduction of high-strength sheet materials (so called “hochfester Blechwerkstoff” in German”) and ultra-high-strength sheet materials (so called “höchstfester Blechwerkstoff” in German) is leading to a continuous increase in the requirements for forming tools in terms of improved abrasion resistance.

In the past, wear in press shops was limited by increasing the amount of lubricant (using additional lubricant) in addition to the coil or sheet-oil-lubrication in order to protect against wear (especially adhesive wear).

However, efficient lubricating oils often contain chlorinated kerosene as an extreme pressure additive, which is relatively toxic and has a negative impact on the environment. Therefore, its use is even more limited nowadays and the tendency is towards minimal lubrication (maximum reduction of additional lubricant).

A suitable surface treatment is therefore advisable to protect the tool surfaces from wear.

In the case of sheet metal forming, adhesive wear is the main wear mechanism. This type of wear basically comprises the following phases:
Initiation of a local transfer of sheet metal material to the tool surface.
Growth of the transfer layer (abrasion of sheet metal material that occurs on the tool surface during the sheet metal forming method) and subsequent abrasive wear on the sheet metal.
Transition to strong adhesive wear.

Zumkeller et al. disclose in WO 2012/072209 A1 that a good solution to increase the corrosion resistance of metal surfaces and to protect them against wear is to nitride these metal surfaces.

WO 2012/072209 A1 mentions special nitriding methods which are marketed as PPD® methods. In particular, Zumkeller et al. describe in WO 2012/072209 A1 a special implementation of this PPD® method, which can lead to improved performance of plastic processing components.

In this respect, reference is made to application WO 2012/072209 A1, the content of which is hereby incorporated into this application.

It is known that an increase in corrosion and wear resistance can be achieved through plasma nitriding, in which the substrates to be nitrided are exposed to a plasma with hydrogen and nitrogen ions under vacuum conditions. Nitriding with a pulsed plasma is also known. Pulsing has several advantages, because on the one hand the process temperature can be selected over a wide range via the power coupling by controlling the pulse duration without having to change the other process parameters, such as the voltage between the electrodes, and on the other hand pulsing can largely prevent sparks from forming during the nitriding process.

Nitriding takes place with diffusion of nitrogen into the surface of the base material, creating a nitriding zone in which the nitrogen forms a compound with the materials of the workpiece close to the surface or the nitrogen (in addition to nitride formation with the alloying elements) forms an intercalated solid solution with the base material a little deeper. This nitriding zone therefore generally comprises a compound layer and a diffusion zone. Accordingly, the compound layer mainly contains nitride compounds. In the case of ferrous substrates, for example, ε-nitride (=Fe₂₍₃₎N) and/or γ-nitride (=Fe₄N) can form in the compound layer.

The present invention deals with the improvement of plasma nitriding methods in order to produce components efficiently and reliably with optimally modified metal surfaces for different applications.

The present improvement presents a further development of the PPD® plasma nitriding method described in WO 2012/072209 A1.

### OBJECT OF THE PRESENT INVENTION

One object of the present invention is to provide a device (hereinafter also referred to as an installation) for the plasma surface treatment (in particular for nitriding) of components which is suitable for the treatment of large components, wherein the device is to comprise a treatment chamber in which the frequently occurring problem with the sealing of large treatment chambers is avoided or completely eliminated.

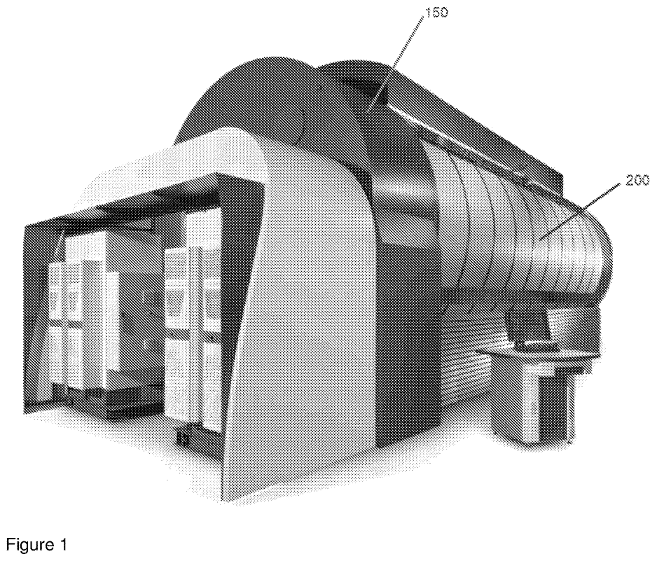

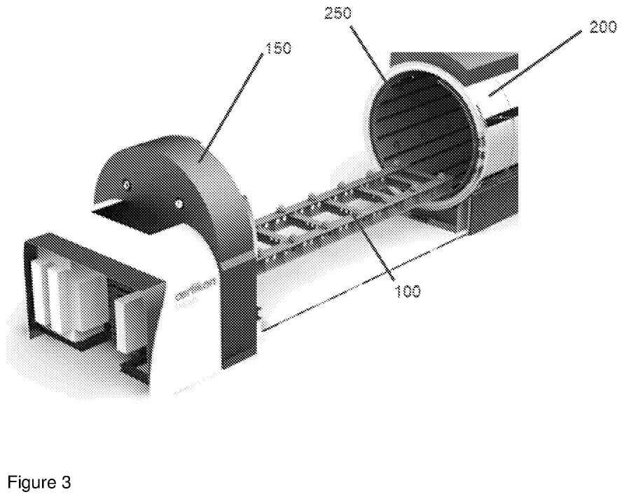

This is particularly difficult because a very large treatment chamber 200 must have a large opening 250 in order to be able to load it with correspondingly large components to be treated (see FIGS. 1 and 3). For example, the plant built by the applicant has the shape of a horizontal cylinder with a length of 10 meters and a diameter of 4.2 meters. The heaviest components, e.g. side wall tools comprising cast iron or steel with dimensions length×width (L×W)=≤10 meters×≤2.9 meters and a element weight of up to 40 tons can thus be introduced into the treatment plant via the base surface 100 of the cylinder, which is configured as a retractable cover 150 (see FIG. 3). When closing the cover, a circumference of π×D, i.e. approximately 3.14×4.2 meters =13 meters, must therefore be sealed vacuum-tight. The applicant has protected the appearance of such a system in the European Design with application number 002071415.

The present invention is intended to address and solve this sealing problem.

Still another object of the present invention is to provide a method for avoiding or satisfactorily controlling the occurrence of arc discharges or arcing (also called “Lichtbogenentladungen” or “Funkendurschlage” in German) frequently associated with plasma treatment method.

A plasma treatment method can be carried out, for example, at an operating voltage of up to approximately 1000 V (up to approximately one thousand volts), with the pressure typically set for carrying out the method being, for example, at a value between 0.5 mbar and 4.5 mbar, e.g. 1.9 mbar

With such method parameters, depending among other things on the geometry of the component to be treated, its temperature distribution, as well as outgassing that cannot always be avoided due to contamination that cannot be removed, plasma breakdowns sometimes occur in the form of local flashes, which can damage the component to be treated, for example at the point of impact.

This problem is also to be addressed by the present invention.

Accordingly, the present invention is based on the object of providing a surface treatment system (in particular, a device for plasma treatment of substrates) with which it is possible to subject large workpieces to be treated (also referred to as large components to be treated) to a plasma treatment, wherein in this system:
the negative pressure required for the treatment can be generated and kept stable due to the inventive measures, and
steps/stages according to the invention can be carried out to prevent the increased occurrence of plasma breakdown on the components to be treated.

### SOLUTION ACCORDING TO THE PRESENT INVENTION

The problem of the present invention is solved by providing a device according to claim 1 and methods according to claims 2 to 7.

FIG. 1 shows the external appearance of a system built by the applicant from one perspective, with the treatment chamber closed.

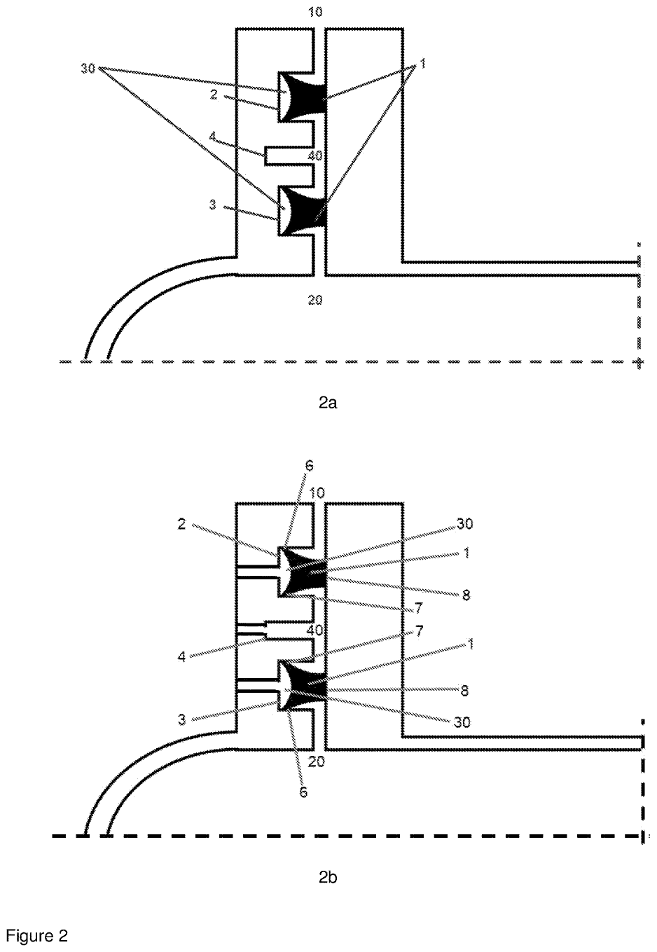

FIG. 2 shows a schematic representation of the inventive solution to the above-mentioned sealing problem.

FIG. 3 shows the appearance of the same system shown in FIG. 1 from a perspective where the treatment chamber is open and the cover of the treatment chamber is correspondingly removed from the rest of the treatment chamber.

### REFERENCE SIGNS

1 seals (inner sealing ring in the inner sealing groove 3 and outer sealing ring 1 in the outer sealing groove 2)
2 outer sealing groove
3 inner sealing groove
4 middle groove
6 sealing lip on the outer sealing ring 1 (in the outer sealing groove 2) facing the outer ambient atmosphere 10, and sealing lip on the inner sealing ring 1 (in the inner sealing groove 3) facing the interior of the treatment chamber 20
7 sealing lip on the outer sealing ring 1 (in the outer sealing groove 2) and sealing lip on the inner sealing ring (in the inner sealing groove 3) facing the support vacuum space 40
8 circular ring surface of the chamber against which the front side of the respective seals 1, is pressed
10 external environment (also called external environmental atmosphere or outer surrounding)
20 treatment chamber interior
30 impact chambers (inner groove areas of the sealing grooves)
40 vacuum space in the sealing system or support vacuum space
100 base surface on which the components to be treated are placed
150 retractable cylinder cover of the treatment chamber
200 cylindrical, horizontal treatment chamber
250 opening the treatment chamber

The special seals 1 are placed in the outer sealing groove 2 and the inner sealing groove 3. The seals are not inflatable seals. The rear sealing lips 6 and 7 of the seals 1 are only pressed against the sealing wall of the groove and on the front side against the system flange (or against the circular ring surface 8 of the system flange) by the impacting of gas, e.g. nitrogen.

A vacuum is generated in the support vacuum space 40 or vacuum space 40, which is called support vacuum because it supports the tightness at the sealing lips 7. The sealing lips 7 are additionally pulled against the groove by the vacuum in the vacuum space 40 and thus support the tightness in the vacuum space 40.

The device (installation) according to the present invention comprises a cylindrical treatment chamber for the plasma-assisted surface treatment of large components, wherein the cylindrical treatment chamber has base surfaces via which the large components to be treated can be loaded and secured, and the treatment chamber is constructed in the form of a horizontal cylinder with at least one lateral cylinder cover which can be opened and closed in a vacuum-tight manner, wherein the cylinder cover is arranged at one of the two ends of the horizontal cylinder and the cylinder cover circumference is at least 8 m, preferably between 10 m and 15 m, so that when the cylinder cover is open, the components to be treated can be loaded into the treatment chamber through this lateral opening, and the cylinder cover comprises an circular ring-shaped cover sealing surface to be positioned opposite the residual cylinder, and the residual cylinder comprises an circular ring-shaped residual cylinder sealing surface to be positioned opposite the cover sealing surface, wherein a sealing system is provided for sealing at the sealing surfaces for vacuum-tight closure in such a way that grooves (preferably a total of three grooves) are milled into one of the sealing surfaces, so that the following conditions are met:
a first circumferential groove is created, which is also referred to below as outer groove 2 (or sealing groove 2)
a second circumferential groove is created, which is also referred to below as inner groove 3 (or sealing groove 3)
the diameter of the circle described by the inner groove is smaller than the diameter of the circle described by the outer groove,
a third groove is provided between the outer groove 2 and the inner groove 3, which is also referred to below as the middle groove 4,
the circle described by the middle groove is smaller than the circle described by the outer groove,
however, the circle described by the middle groove is larger than the circle described by the inner groove,
the three grooves are each centered around a center point, preferably the same center point, so that they do not intersect,
a sealing ring 1 is provided in each of the outer and inner grooves,
at least one of the sealing rings 1, but preferably both, have a shape such that when the cover is pressed against the circular ring surface of the remaining chamber, a flat sealing surface is pressed against it, while in the direction of the groove depth the sealing ring has an outward-facing sealing lip (also referred to as an outward-facing flank of the sealing ring) and an inward-facing sealing lip (also referred to as an inward-facing flank of the sealing ring), which fit tightly against the groove walls, and the arrangement is configured in such a way that when the cover sealing surface and the residual cylinder sealing surface are pressed together, an interspace system is created which is sealed off from the external environment 10 and from the cylinder interior 20 of the system (i.e. the chamber or the treatment chamber or the vacuum treatment chamber), wherein the interspace system comprises two impact chambers 30 and a vacuum space 40 in which a so-called supporting vacuum is generated, wherein the sealing system comprises elements for impacting the impact chambers 30 with overpressure of at least 0.1 mbar to 1 mbar (i.e. between 0.1 mbar and 1 mbar), preferably of at least 0.1 bar, particularly preferably of at least 0.2 bar and very particularly preferably of at least 0.3 bar.

No pneumatic systems (no compressed air) are used for the impact, because such systems can have many adverse effects, such as penetration of atmospheric oxygen into the treatment chamber, which can lead to poor nitriding results. Therefore, according to the invention, the impact chambers are impacted with a defined gas (or gas mixture), wherein the gas or gas mixture does not comprise oxygen. Preferably, the impact chambers are impacted with nitrogen between 0.1 mbar and 1 mbar.

According to a first aspect of the present invention, the inventive device thus comprises a cover which is sealed through a sealing system as mentioned above. Where the cover is pressed against the treatment chamber, the chamber has a circular ring-shaped surface for which a mating surface is provided in the cover. Milled into this surface of the cover is a first circumferential groove, which is also referred to as outer groove 2 (also called sealing groove 2) in the present description. Also milled into this surface of the cover is a second circumferential groove, which is also referred to as inner groove 3 (also referred to as sealing groove 3) in the present description. The diameter of the circle described by the inner groove is smaller than the diameter of the circle described by the outer groove. A third groove is provided between the outer groove and the inner groove, which is also referred to as the middle groove 4 in the present description. The circle described by the middle groove is smaller than the circle described by the outer groove. However, the circle described by the middle groove is larger than the circle described by the inner groove. All three grooves (the inner, middle and outer groove respectively) are essentially centered around the same center point so that they do not intersect.

A sealing ring 1 is provided in each of the outer and inner grooves. At least one of the sealing rings 1, but preferably both, have a shape such that when the cover is pressed against the circular ring surface of the remaining chamber, a flat sealing surface is pressed against it, while in the direction of the groove depth, the sealing ring has an outward-facing flank and an inward-facing flank, which fits tightly against the groove walls.

The schematic representation in FIG. 2 shows a cross-section through a part of such a cover-treatment chamber combination. It can be seen that due to the seals 1 in the outer groove 2 and in the inner groove 3, a space system is created between these grooves which is separated and sealed off from both the outer surroundings 10 and the chamber interior 20 and which comprises three spaces (two impact chambers 30 and a vacuum space 40), the vacuum space 40 comprising the central groove 4.

In the present description, the vacuum space 40 is also referred to as supporting vacuum space 40.

According to a feature essential in relation to this aspect of the present invention, the treatment plant comprises elements for gas impacting each impact chamber with an overpressure. According to the invention, the above-mentioned elements comprise at least one gas supply, preferably a nitrogen gas supply, so that each impact chamber can be impacted with an overpressure of 0.1 mbar to 1 mbar, e.g. 0.3 bar, through gas, preferably nitrogen gas. Due to the impact of the special seals 1 (seals that are not inflatable seals and preferably a shape as described above, which are placed in the outer sealing groove 2 and in the inner sealing groove 3), the respective rear sealing lips 6 and 7 of the sealing rings 1 are pressed against the sealing wall 10 of the respective grooves 2 and 3 and the seals 1 are simultaneously pressed towards the treatment chamber, whereby these sealing rings 1 are pressed much more effectively and in an improved way against the circular ring surface 8 of the chamber

The flanks (sealing lips) of the sealing rings prevent, like a valve flap, the nitrogen from continuing to flow.

According to a preferred procedure, the overpressure is impacted to the impact chamber at least twice, namely at the beginning of the evacuation stage, essentially in order to position the sealing rings well in advance, and at the end of the evacuation process, i.e. when mechanical displacement no longer occurs due to the forces acting on the system during evacuation and the seals and in particular the flanks (sealing lips) and/or flat parts are finally to be brought into the correct position. A vacuum is generated in the middle groove, the so-called support vacuum.

Only the impact chambers 30 (the seals 1 in the outer groove 2 and inner groove 3) are then impacted with nitrogen, while the space in the groove 4 is under vacuum.

According to a further aspect of the present invention, a method is proposed for suppressing or at least reducing the occurrence of spark discharges that are harmful to the substrate as described above.

The method is carried out in the equipment described above (also called device or plasma treatment equipment), which includes a powerful pulsed plasma generator integrated with an automatic safety control system to ensure precise control of the process and safe treatment of the components to be treated.

Despite the unusually high process power of up to 1,000 kW, the temperature ramps during heating (up to 530 °C) and cooling can be adjusted as required in order to keep stresses in the components (in the case of tools, tool stresses) very low, even with the largest dimensions, and even to compensate for them. And despite extremely high pulse power for optimum treatment results, the unimaginably fast-reacting plasma control in the range of a few millionths of a second ensures particularly gentle interaction between the high-energy plasma and the functional surfaces of the components (e.g. tool functional surfaces). The combination of arc management (management of arc discharges or spark discharges) of the plasma source and the adapted system control reacts reliably when spark discharges occur and thus protects the surfaces of the treated substrates (e.g. forming tools) from damage.

The system works at a specified typical operating voltage. In this case, this is typically up to 1000 V. With an accumulation of the occurrence of these spark discharges (for example, when spark discharges occur in a number m range from 7 to 25 spark discharges in a time interval of 250 milliseconds), it was found out, that in many cases an abrupt reduction of the operating voltage by a voltage value, for example in the range from 10 V to 100 V, preferably in the range from 10 V to 70 V (e.g. an abrupt reduction of the operating voltage by 50 V), will stop the occurrence of spark discharges, even if the operating voltage is then slowly (i.e. over a period longer than one minute) and stagewise restored to the original value of the operating voltage. The system also operates under a predetermined working pressure of X mbar. In this example, this is typically 1.9 mbar. Surprisingly it was discovered, that a stagewise increase or decrease in pressure can also and additionally contribute to a reduction in the occurrence of spark discharges. For example, the pressure can be increased from 1.9 mbar to 2.5 mbar in a total of 6 stages of 0.1 mbar increments, or reduced from 1.9 mbar to 1.0 mbar in a total of 9 stages of 0.1 mbar increments. The system continues to run stably despite the changed parameters. Later, it is possible to slowly return to the typical operating pressure.

The inventors have found that an abrupt reduction in the operating voltage by a voltage value, particularly in the above-mentioned preferred range (from 10 V to 70 V), has the advantage that the risk of the plasma being extinguished (depending on the load and process parameters) is lower.

The inventors have developed the hypothesis that an abrupt change in the conditions in the system, at least as far as voltage and pressure are concerned, removes the preconditions for spark discharges to occur and they can therefore no longer take place.

According to yet another aspect of the present invention, the method has been further developed in such a way that a cleaning stage is integrated prior to plasma ignition, in the pre-vacuum, the cleaning stage comprises a high heating without plasma, which is carried out in such a way that oils and impurities are cracked from the substrates prior to plasma ignition, so that an upstream annealing treatment of the components is not necessary.

This is primarily to avoid the otherwise indispensable, but fundamentally damaging, upstream annealing treatment (also known as pre-annealing) with additional, often too steep heating and cooling ramps and corresponding residual stress risks. Above all, however, it also avoids harmful surface and grain boundary oxidation, which can only be eliminated to a limited extent due to pre-annealing (which always takes place in air), even with extensive intermediate polishing. Furthermore, the elimination of pre-annealing reduces the risk of material waxing, which can be particularly important for cast iron grades with thermally unstable pearlite.

In the interest of optimally assured treatment results, the advanced method is carried out in such a way that oils in the components to be treated (e.g. forming tools) and residues on paints and plastics are cracked during high-temperature heating without plasma and condense in cold areas.

The tools can be heated up in a gentle and controlled manner by measuring the temperature of the components to be treated and implementing an optimized ramp function. This is followed by the plasma stage, which can be started effortlessly thanks to the upstream inventive stage (cleaning stage when heating up without plasma) and is immediately and evenly present on the tools, resulting in a homogeneous heat input.

According to yet another aspect of the present invention, the method was further developed in such a way that the occurrence of hydrogen embrittlement was massively reduced by adjusting the process gas composition.

An important aspect of plasma surface treatment of metallic surfaces is the problem of hydrogen embrittlement. This refers to the change in the strength of metals due to the penetration and incorporation of hydrogen into their metal lattice. As the large components to be treated, for example forming tools, usually have areas that have been modified in advance by the application of welding, there is a risk of spalling due to possible hydrogen embrittlement, especially as preferred diffusion paths can be determined by the existing interface. In conjunction with thermal stresses, there is therefore a tendency for premature material failure. Surprisingly, the inventors found that by changing the process gas composition (precursor composition) from N₂/H₂=1:3 to N₂/H₂=1:1 or N₂/H₂ between 1.15:1 and 1:1.15, this risk was massively reduced.

A particularly preferred method according to the present invention for manufacturing components with modified metal surfaces preferably comprises the following stages:
a. Providing at least one substrate to be treated (at least one component, e.g. a large forming tool) with at least one substrate surface to be treated.
b. Optional-polishing of the substrate surface to be treated (pre-polishing).
c. Loading a vacuum chamber (of a plasma treatment system) with the at least one substrate to be treated, wherein the at least one substrate is held electrically insulated from the vacuum chamber wall such that the vacuum chamber wall can form an anode and the at least one substrate can form at least part of a cathode.
d. Closing the vacuum chamber by sealing one or more openings through which the vacuum chamber has been loaded with at least one substrate to be treated,
e. Evacuate the vacuum chamber to a working pressure (preferably up to 0.05 mbar).
f. Heating up the substrate in a pre-vacuum through electric heaters, whereby the substrates are heated up to a substrate temperature between 100 °C and 300 °C, so that a cleaning stage is carried out in this way, in which oils and impurities are scraped from the substrates prior to plasma ignition (this process stage is also to be understood in the context of the present invention as an integrated cleaning stage or cleaning stage of the substrate during heating up without plasma, wherein the heating up as mentioned above is preferably carried out up to a temperature between 100 °C and 300 °C, or between 220 °C and 300 °C, for example up to 250 °C).
g. Introducing of a gas mixture into the vacuum chamber, wherein the gas mixture contains both hydrogen and nitrogen in elemental and/or bound form and preferably the process gas composition in the vacuum chamber is in the range N₂/H₂ between 1.15:1 and 1:1.15 or at N₂/H₂=1:1.
h. Ignition of the plasma at a substrate temperature between 100 °C and 300 °C
i. Nitriding is carried out by applying a pulsed voltage between the anode and cathode in such a way that the gas mixture is ionized and a plasma is formed in the vacuum chamber-Nitriding via pulsed DC plasma is preferably carried out at a substrate temperature of between 300-560 depending on the type, dimensions, weight and material of the substrate (e.g. whether steel or cast iron).
j. Cooling.
k. Optional—polishing (re-polishing).

The present invention makes it possible to treat tools in such a way that all the above-mentioned requirements can be met in the case of forming tools for metal forming. Thus, it is also possible to realize the overhaul (local welding) of the tools or forming tools treated according to the invention without having to carry out a prior denitrification. In addition, the present invention enables the treatment of tools or forming tools in such a way that the usual use of additional lubricant can be practically dispensed with, and thus maximum minimum lubrication can be achieved.

More specifically, the present invention mainly relates to a device and methods for plasma treatment of components, wherein the device is particularly suitable for plasma treatment of large components, and the methods are suitable for excellent and stable plasma treatment of components, particularly components:

A device for plasma treatment of components in a plasma treatment chamber comprising a cylindrical treatment chamber for plasma-assisted surface treatment of components, wherein the cylindrical treatment chamber has base surfaces via which the components to be treated can be loaded and secured, and the treatment chamber is constructed in the form of a horizontal cylinder with at least one lateral cylinder cover which can be opened and closed in a vacuum-tight manner, wherein the cylinder cover is arranged at one of the two ends of the horizontal cylinder and the cylinder cover circumference is at least 8 m, so that when the cylinder cover is open, the components to be treated can be loaded into the treatment chamber through this lateral opening, and the cylinder cover comprises a circular ring-shaped cover sealing surface to be placed opposite the residual cylinder, and the residual cylinder comprises a circular ring-shaped residual cylinder sealing surface to be placed opposite the cover sealing surface, wherein a sealing system is provided for sealing at the sealing surfaces for vacuum-tight closure, in such a way that grooves are milled into one of the sealing surfaces, so that the following conditions are fulfilled:
a first circumferential groove is created, which is also referred to below as outer groove 2,
a second circumferential groove is created, which is also referred to below as inner groove 3,
the diameter of the circle described by the inner groove is smaller than the diameter of the circle described by the outer groove,
a third groove is provided between the outer groove 2 and the inner groove 3, which is also referred to below as the middle groove 4,
the circle described by the middle groove is smaller than the circle described by the outer groove,
however, the circle described by the middle groove is larger than the circle described by the inner groove,
the three grooves are each centered around a center point, preferably the same center point, so that they do not intersect,
a sealing ring 1 is provided in each of the outer and inner grooves,
at least one of the sealing rings 1, but preferably both, have a shape such that when the cover is pressed against the circular ring surface 8 of the remaining chamber, a flat sealing surface is pressed against it, while in the direction of the groove depth the sealing ring has an outward-facing sealing lip 6 (where “outward-facing” elements either in the direction of the outer surrounding 10 or in the direction of the cylinder interior 20, as shown in FIG. 2b) and an inward-facing sealing lip 7 (where “inward-facing” elements in the direction of the support vacuum space 40, as shown in FIG. 2b), which fit tightly against the groove walls,
the arrangement is configured in such a way that when the cover sealing surface and the residual cylinder sealing surface are pressed together, an interspace system is formed which is sealed off from the outer surrounding 10 and from the cylinder interior 20 of the system, wherein the interspace system comprises two impact chambers 30 and a supporting vacuum space 40, and wherein the sealing system comprises devices for impacting the impact chambers 30 through a gas, preferably nitrogen gas, with an overpressure of between 0.1 and 1 mbar.

A method for plasma treatment components in a plasma treatment chamber, wherein to produce components having modified metal surfaces, the method comprises the stages of:
a. Providing at least one substrate to be treated (at least one component, e.g. a large forming tool) with at least one substrate surface to be treated.
b. Optional—Polishing of the substrate surface to be treated (i.e. pre-polishing if necessary).
c. Loading a vacuum chamber (of a plasma treatment system) with the at least one substrate to be treated, wherein the at least one substrate is held electrically insulated from the vacuum chamber wall such that the vacuum chamber wall can form an anode and the at least one substrate can form at least part of a cathode.
d. Closing the vacuum chamber by sealing one or more openings through which the vacuum chamber has been loaded with at least one substrate to be treated,
e. Evacuate the vacuum chamber to a working pressure (preferably up to 0.05 mbar).
f. Heating up the substrate in a pre-vacuum through electric heaters, whereby the substrates are heated up to a substrate temperature of between 100 °C and 300 °C, so that a cleaning stage is carried out in this way, in which oils and impurities are cracked from the substrates before plasma ignition.
g. Introducing a gas mixture into the vacuum chamber, wherein the gas mixture preferably contains both hydrogen and nitrogen in elemental and/or bound form and preferably the process gas composition in the vacuum chamber is in the range N₂/H₂ between 1.15:1 and 1:1.15 or at N₂/H₂=1:1.
h. Ignition of the plasma at a substrate temperature between 100 °C and 300 °C.
i. Carrying out the plasma treatment (wherein the plasma treatment is in particular a nitriding or at least comprises a nitriding) by applying a pulsed voltage between anode and cathode such that the gas mixture is ionized and a plasma is formed in the vacuum chamber—The nitriding is preferably performed via pulsed DC plasma and also preferably at a substrate temperature between 300-560 °C, wherein the substrate temperature depends on the type, dimensions, weight and material of the substrate (e.g. whether steel or cast iron).
j. Cooling.
k. Optional—polishing (i.e. re-polishing if necessary).

According to a preferred embodiment, when carrying out stage i. listed above, a method is used that enables the plasma treatment to be carried out in a stable manner.

According to the present invention, one such method which enables stable plasma treatment is a method for plasma treatment of components in a plasma treatment chamber with a predetermined operating voltage and a predetermined treatment pressure, wherein, in the event of an accumulation of arc discharges, the absolute value of the operating voltage is abruptly reduced by an absolute voltage amount in the range from 10 V to 100 V in order to suppress the arc discharges and the operating voltage is then reset to the original operating voltage via a stagewise process lasting at least one minute, wherein an occurrence of arc discharges from a number in the range from 7 to 25 arc discharges in a time interval of 250 ms is recognized as an accumulation. According to a preferred embodiment of this method, the operating pressure is additionally increased stagewise, preferably in 0.1 mbar stages up to a temporary maximum value of 2.5 mbar and/or the operating pressure is reduced stagewise of 0.1 mbar up to a minimum value of 0.5 mbar, whereby the original operating pressure is between 0.5 mbar and 4.5 mbar.

Preferably, the inventive methods described above are carried out in a device according to the invention as described above.

According to the present invention, the substrates to be treated are preferably tools for forming or for plastics processing.

However, the present invention is not limited to the plasma treatment of these tools.

What is claimed is:

1-7. (canceled)

8. A device for plasma treatment of components in a plasma treatment chamber, the device comprising a cylindrical treatment chamber for plasma-assisted surface treatment of components, wherein the cylindrical treatment chamber has base surfaces via which the components to be treated can be loaded and secured, and the treatment chamber is constructed in the form of a horizontal cylinder with at least one lateral cylinder cover which can be opened and closed in a vacuum-tight manner, wherein the cylinder cover is arranged at one of the two ends of the horizontal cylinder and the cylinder cover circumference is at least 8 m, so that when the cylinder cover is open, the components to be treated can be loaded into the treatment chamber through this lateral opening, and the cylinder cover comprises a circular ring-shaped cover sealing surface to be placed opposite the residual cylinder, and the residual cylinder comprises a circular ring-shaped residual cylinder sealing surface to be placed opposite the cover sealing surface, wherein a sealing system is provided for sealing at the sealing surfaces for vacuum-tight closure, in such a way that grooves are milled into one of the sealing surfaces, so that the following conditions are fulfilled:
a first circumferential groove is created, which is also referred to below as the outer groove,
a second circumferential groove is created, which is also referred to below as the inner groove,
the diameter of the circle described by the inner groove is smaller than the diameter of the circle described by the outer groove,
a third groove is provided between the outer groove and the inner groove, which is also referred to below as the middle groove,
the circle described by the middle groove is smaller than the circle described by the outer groove,
however, the circle described by the middle groove is larger than the circle described by the inner groove,
the three grooves are each centered around a center point, so that they do not intersect,
a sealing ring is provided in each of the outer and inner grooves,
at least one of the sealing rings, have a shape such that when the cover is pressed against the circular ring surface of the remaining chamber, a flat sealing surface is pressed against it, while in the direction of the groove depth the sealing ring has an outward-facing sealing lip and an inward-facing sealing lip, which fit tightly against the groove walls,
the arrangement is configured in such a way that when the cover sealing surface and the residual cylinder sealing surface are pressed together, an interspace system is formed which is sealed off from the outer surrounding and from the cylinder interior of the system, wherein the interspace system comprises two impact chambers and a supporting vacuum space, and wherein the sealing system comprises elements for impacting the impact chambers through a gas, with an overpressure of between 0.1 and 1 mbar.

9. The device according to claim 8, wherein the three grooves are each centered around the same center point.

10. The device according to claim 8, wherein both sealing rings have a shape such that when the cover is pressed against the circular ring surface of the remaining chamber, a flat sealing surface is pressed against it, while in the direction of the groove depth the sealing ring has an outward-facing sealing lip and an inward-facing sealing lip, which fit tightly against the groove walls.

11. The device according to claim 8, wherein the gas is nitrogen gas.

12. The device according to claim 8, wherein the lateral cylinder cover is configured as a retractable cover.

13. The device according to claim 8, wherein the cylinder cover circumference is between 10 m and 15 m.

14. The device according to claim 8, wherein the device has a length of at least 10 m and a width of at least 4.2 m.

15. The device according to claim 8, wherein the sealings are designed not inflatable.

16. A method for plasma treatment of components in a plasma treatment chamber with a predetermined operating voltage and a predetermined treatment pressure, wherein, in the event of an accumulation of occurrences of arc discharges, the absolute value of the operating voltage is abruptly reduced by an absolute voltage amount in the range from 10 V to 100 V in order to suppress the arc discharges and the operating voltage is then set back to the original operating voltage through a stagewise process lasting at least one minute, whereby an occurrence of arc discharges from a number in the range of 7 to 25 arc discharges in a time interval of 250 ms is recognized as an accumulated occurrence.

17. The method according to claim 16, wherein in addition the operating pressure is temporarily increased stagewise up to a maximum value of 2.5 mbar and/or the operating pressure is reduced stagewise in 0.1 mbar stages up to a minimum value of 0.5 mbar, the original operating pressure being between 0.5 mbar and 4.5 mbar.

18. The method according to claim 16, wherein the operating pressure is temporarily increased stagewise in 0.1 mbar stages up to a maximum value of 2.5 mbar.

19. A method for plasma treatment of components in a plasma treatment chamber, wherein the method comprises the following stages for producing components with modified metal surfaces:
a. providing at least one substrate to be treated with at least one substrate surface to be treated,
b. pre-polish the substrate surface to be treated, if necessary,
c. loading a vacuum chamber of a plasma treatment system with the at least one substrate to be treated, wherein the at least one substrate is held electrically insulated from the vacuum chamber wall such that the vacuum chamber wall can form an anode and the at least one substrate can form at least part of a cathode,
d. closing the vacuum chamber by sealing one or more openings through which the vacuum chamber has been loaded with at least one substrate to be treated,
e. evacuate the vacuum chamber to a working pressure,
f. heating up the substrate in a pre-vacuum through electric heaters, whereby the substrates are heated up to a substrate temperature of between 100 °C and 300 °C, so that a cleaning stage is carried out in this way, in which oils and impurities are cracked from the substrates before plasma ignition,
g. introducing a gas mixture into the vacuum chamber, whereby the gas mixture contains both hydrogen and nitrogen in elementary and/or bound form,
h. ignition of the plasma at a substrate temperature between 100 °C and 300 °C,
i. carrying out the plasma treatment, which is or comprises nitriding, by applying a pulsed voltage between anode and cathode such that the gas mixture is ionized and a plasma is formed in the vacuum chamber,
j. cooling,
k. re-polish, if necessary.

20. The method according to claim 19, wherein the vacuum chamber is evacuated to a working pressure up to 0.05 mbar.

21. The method according to claim 19, wherein the substrates to be treated are tools for forming or for plastics processing.
